(19) United States
(12) Patent Application Publication
(10) Pub. No.: US 2025/0065509 A1
(43) Pub. Date: Feb. 27, 2025

(54) ROBOT BLADE AND WAFER BREAKAGE PREVENTION SYSTEM

(71) Applicant: Applied Materials Israel Ltd., Rehovot (IL)

(72) Inventors: Hagay Cafri, Beit Hashmonai (IL); Erez Admoni, Petach Tikva (IL)

(73) Assignee: Applied Materials Israel Ltd., Rehovot (IL)

(21) Appl. No.: 18/236,322

(22) Filed: Aug. 21, 2023

(51) Int. Cl. B25J 11/00; B25J 9/16; B25J 17/02

(52) U.S. Cl. CPC B25J 11/0095; B25J 9/1664; B25J 17/0275

(57) ABSTRACT

An apparatus that includes an end effector for handling and transporting wafers, the end effector including: a base portion having a first end adapted to be attached to a robot; a wafer support platform having a surface to support a wafer, a slidable joint coupling the base portion to the wafer support platform; and a sensor configured to detect when the wafer support platform slides relative to the base portion beyond a predetermined distance.

### BACKGROUND OF THE INVENTION

The manufacture of semiconductor devices typically includes many different processing steps that are performed in semiconductor fabrication facility by multiple different types of tools. For example, in order to complete the fabrication of integrated circuits on a semiconductor wafer, the wafer might be transferred to and processed by a suite of tools that includes a chemical vapor deposition tool, a physical vapor deposition tool, an etch tool, a chemical mechanical polishing tool, a photolithography tool, and/or a metrology tool, among many others.

In order to transfer wafers between processing tools or within different chambers of a multi-chamber processing tool, wafers are typically picked up and transferred by a robot. The wafers can be rather large and fragile so wafer transfer robots typically include a robot arm that is outfitted with a specially designed end effector.

FIG. 1A is a simplified top view illustration of one example of a common end effector 100. As shown in FIG. 1A, end effector 100 includes a base portion 110, a sample support platform 130 and an arm 120 that extends between the base portion and support platform. Base portion 110 can include multiple apertures 112 that enable the end effector to be attached to a robot (e.g., with screws or other appropriate fasteners). Support platform 130, which is sometimes referred to as a “blade”, is connected to arm 120 at a neck region 132 and includes first and second fingers 134, 136 disposed in a spaced apart relationship at a distal end of end effector 100.

Within a semiconductor fabrication facility, wafers are often stored in a specialized container (e.g., in a Front Opening Unified Pod “FOUP” or similar container) in a vertically stacked arrangement with a small gap (e.g., 10 mm) between each adjacent wafer. In order for end effector 100 to be able to place wafers in the container and extract wafers from the container, the end effector needs to be very thin as shown in FIG. 1B, which is a simplified side view of end effector 100. For example, it is common for the support plate of end effector 100 to have a thickness, T, of no more than 5 mm and sometimes less than 2 mm.

Reference is now made to FIG. 2A, which is a simplified top view illustration of end effector 100 supporting a semiconductor wafer 200. As shown, support platform 130 is sized in relation to wafer 200 to adequately support the wafer as it is transported by the robot to which end effector 100 is attached. While not shown, support platform 130 can include one or more features that enable end effector 100 to securely grip wafer 200 during transport. As non-limiting examples, end effector 100 can include grip pads, vacuum channels or other mechanisms to securely affix wafer 200 to the support platform.

Semiconductor wafer 200 is typically even thinner than support platform 130. As shown in FIG. 2A, which is a simplified side view of end effector 100 carrying semiconductor wafer 200, wafer 200 can have a thickness, Tw, which for some wafers is less than 1 mm.

Thus, as can be appreciated, wafer 200 can be both rather large and bulky (300 mm wafers have a diameter of almost a foot) yet very fragile. Wafer 200 can also be very expensive.

During the transport of wafer 200, it is sometimes possible for the robot to which end effector 100 is attached to suffer a fault or similar problem that causes the robot to impart end effector on a unintended path that results in either the end effector or wafer 200 colliding with an object (e.g., a portion of a processing tool) within the fabrication facility. Such an unplanned and unintended collision can damage the wafer, the end effector and/or the robot itself. And, even if the collision does not cause any immediate damage, the collision could alter the trajectory of the edge effector and cause it to be misaligned with the next wafer it transports. The misalignment can then result in an unbalanced wafer that could be subsequently damaged.

Accordingly, improvements to the mechanisms, such as an end effector, that transfer wafers or other samples into or out of processing chambers or between processing tools are desirable.

### BRIEF SUMMARY OF THE INVENTION

Embodiments of the disclosure provide an improved end effector that can be used to transfer samples, such as semiconductor and other thin wafers or substrates, between processing chambers or stations in a fabrication or similar facility. End effectors disclosed herein can be split into two rigid components, a base and a sample support, mechanically joined together by a joint that allows the two components to slide with respect to each other. The end effector can also include an electrical sensing mechanism that detects when the components slide beyond a predetermined amount enabling a controller to cease motion of the end effector to prevent potential damage to the end effector, a sample or wafer supported by the end effector and/or the robot that the end effector is coupled to. While embodiments disclosed herein can be used to transfer a variety of different types of samples, some embodiments are particularly useful in transferring thin wafers, such as wafers used in the fabrication of semiconductor or similar devices.

In some embodiments, an apparatus that includes an end effector for handling and transporting wafers is disclosed. The end effector can include: a base portion having a first end adapted to be coupled to a robot; a wafer support platform having a surface to support a wafer; a slidable joint coupling the base portion to the wafer support platform; and a sensor configured to detect when the wafer support platform slides relative to the base portion beyond a predetermined distance.

In various implementations, the end effector can include one or more of the following features. The slidable joint can include a spring that biases the wafer support platform towards the base portion by imparting a biasing force that clamps the base portion and the wafer support platform in a fixed position until a force greater than the biasing force is imparted upon the end effector causing the wafer support platform to slide relative to the base portion. The base portion can further include a second end opposite the first end. The wafer support platform can include first and second opposing ends with a plurality of fingers at the second end of the wafer support platform. The slidable joint can couple the second end of the base portion to the first end of the wafer support platform such that the base portion and wafer support platform are aligned longitudinally along a length of the end effector with the plurality of fingers at a distal end of the end effector. The apparatus or end effector can further include a controller operatively coupled to the sensor and configured to stop movement of the end effector if the sensor detects that the wafer support platform slid horizontally with respect to the base portion more than the predetermined distance. The second end of the base portion can include a first aperture. The first end of the wafer support platform can include a second aperture aligned with the first aperture. The slidable joint can include a fastener that extends through the first and second apertures. The fastener can include an end plate at its distal end. The spring can be disposed between the end plate and one of the wafer support platform or the base portion. The base portion can include a plurality of apertures at its first end in a configuration that enables the base portion to be attached to the robot.

In some embodiments, the slidable joint can include first and second coplanar concentric rings. The first ring can be positioned at a surface of one of the base portion or wafer support platform and the second ring can be positioned at an opposing surface of the other of the base portion or wafer support platform. The first and second rings can be sized such that an outer diameter of the first ring fits within and is spaced apart from an inner diameter of the second ring. The distance between the outer diameter of the first ring to the inner diameter of the second ring can define the predetermined distance. The distance between the outer diameter of the first ring to the inner diameter of the second ring can be 1.0 mm or less. The sensor can include electrically conductive lines that form a short circuit when the first and second rings come into physical contact with each other.

In additional embodiments, the slidable joint can include an intermediate plate secured in a fixed position between the base portion and the wafer support platform by the slidable joint. In some of such implementations, the slidable joint can include first and second sets of electrically conductive rings. The first set of electrically conductive rings can include first and second coplanar concentric rings with the first ring positioned at a surface of one of the wafer support platform or the intermediate plate and the second ring positioned at an opposing surface of the other of the wafer support platform or intermediate plate. The first and second rings can be sized such that an outer diameter of the first ring fits within and is spaced apart from an inner diameter of the second ring. The second set of electrically conductive rings can include third and fourth coplanar concentric rings spaced directly next to each other in an oppositional relationship with the third ring positioned at a surface of the intermediate plate and the fourth ring positioned at a surface of the base portion. The third and fourth rings can be spaced apart from each other along the z-axis by a gap that prevent the rings from contacting each other during normal operation of the end effector.

In still other embodiments, the slidable joint can include a ball and socket joint.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1A is a simplified top view illustration of one example of a previously known end effector;

FIG. 1B is a simplified side view illustration of the end effector shown in FIG. 1A;

FIG. 2A is a simplified top view illustration of the end effector shown in FIG. 1A carrying a semiconductor wafer;

FIG. 2B is a simplified side view illustration of the end effector and wafer shown in FIG. 2A;

FIG. 3A is a simplified top view illustration of an end effector according to some embodiments disclosed herein;

FIG. 3B is a simplified bottom view illustration of the wafer carrier portion of the end effector shown in FIG. 3A;

FIG. 3C is simplified top view illustration of the base portion of the end effector shown in FIG. 3A;

FIG. 3D is a simplified cross-sectional view illustration of the end effector shown in FIG. 3A with the wafer carrier and base portions in an unconnected, spaced apart relationship;

FIG. 3E is an expanded cross-sectional view of a slidable joint that can be used to join the wafer carrier and base portions of the end effector shown in FIG. 3A according to some embodiments;

FIG. 4A is a simplified diagram illustrating possible slidable movement between the wafer carrier and base portions according to some embodiments;

FIG. 4B is a simplified cross-sectional view illustration of the end effector shown in FIG. 3A after the wafer carrier portion has moved to a position that triggers an impact event according to some embodiments;

FIG. 5A is a simplified cross-sectional view illustration of an end effector according to some embodiments;

FIG. 5B is an expanded cross-sectional view of a slidable joint that can be used to join the wafer carrier and base portions of the end effector shown in FIG. 5A according to some embodiments;

FIG. 6A is a simplified cross-sectional view illustration of an end effector according to some embodiments;

FIG. 6B is a simplified cross-sectional view illustration of the end effector shown in FIG. 6A moved horizontally into a position that triggers an impact event according to some embodiments; and

FIG. 6C is a simplified cross-sectional view illustration of the end effector shown in FIG. 6A moved horizontally into a position that triggers an impact event according to some embodiments.

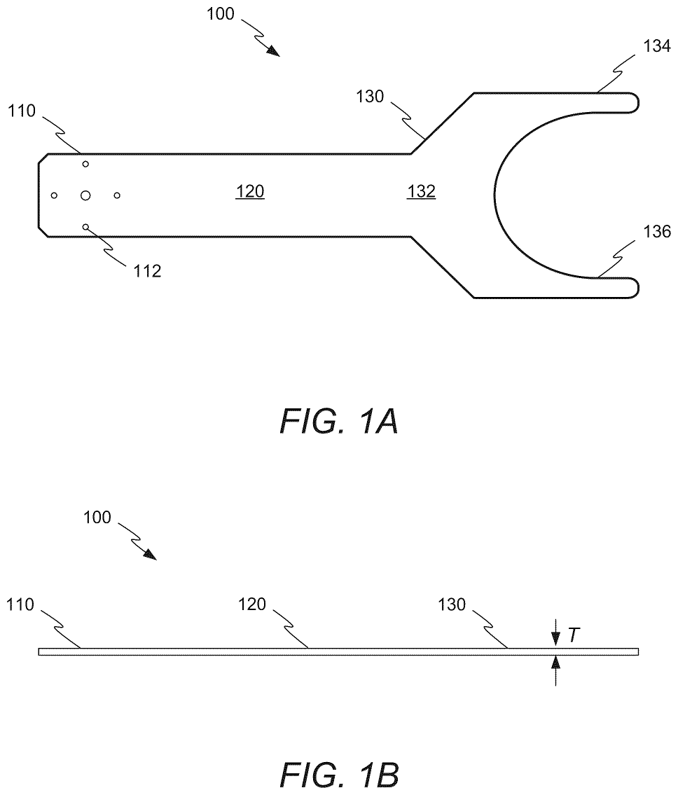

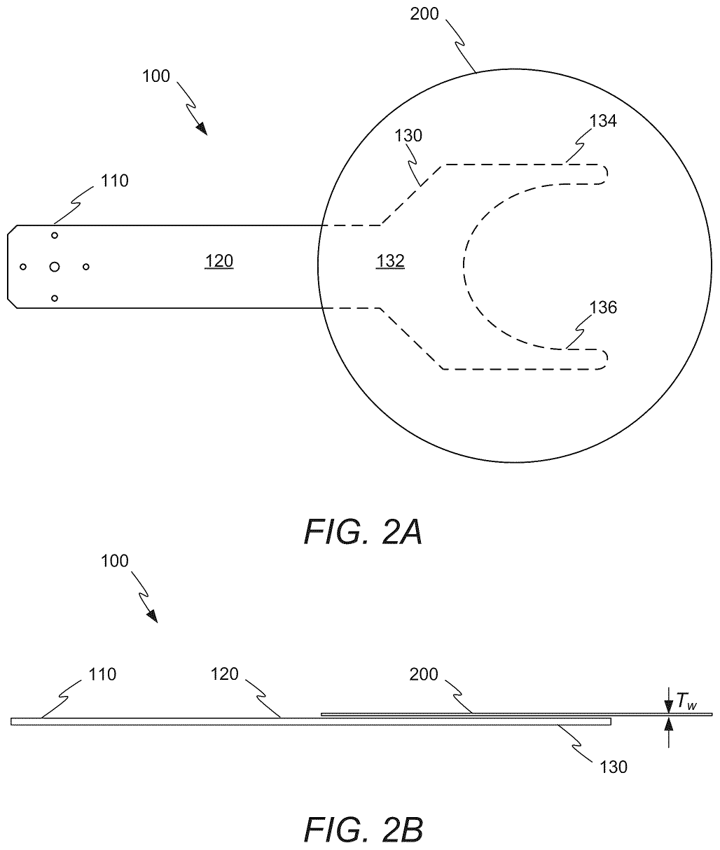

### DETAILED DESCRIPTION OF THE INVENTION

Embodiments of the disclosure provide an improved end effector that can be used to transfer samples, such as semiconductor and other thin wafers or substrates, between processing chambers or stations in a fabrication or similar facility. End effectors disclosed herein can be split into two rigid components, a base and a sample support, mechanically joined together by a joint that allows the two components to slide with respect to each other. The end effector can also include an electrical sensing mechanism that detects when the components slide beyond a predetermined amount enabling a controller to cease motion of the end effector to prevent potential damage to the end effector, a sample or wafer supported by the end effector and/or the robot that the end effector is coupled to. While embodiments disclosed herein can be used to transfer a variety of different types of samples, some embodiments are particularly useful in transferring thin wafers, such as wafers used in the fabrication of semiconductor or similar devices.

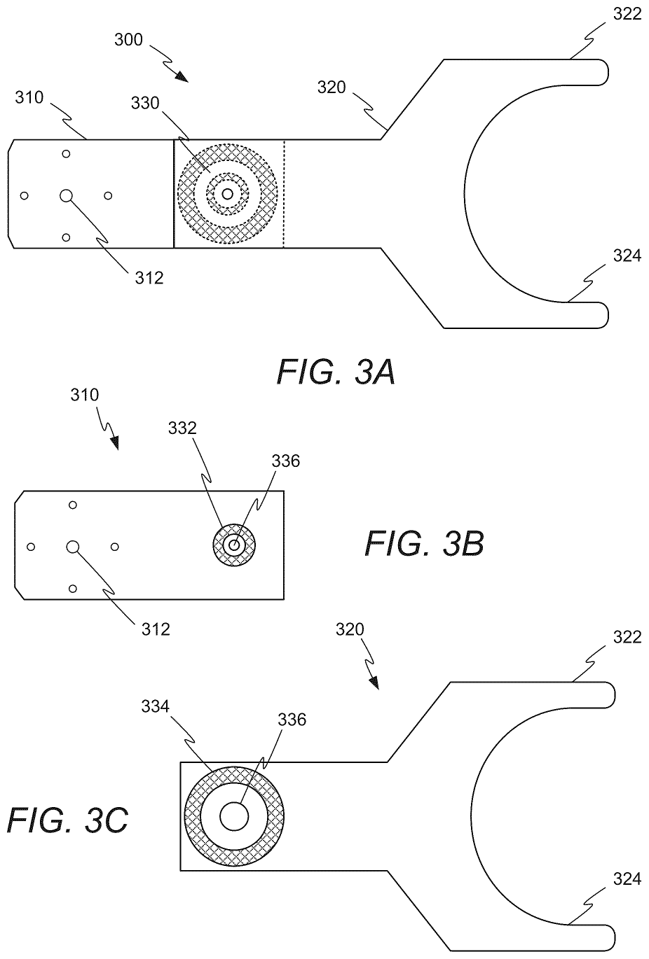

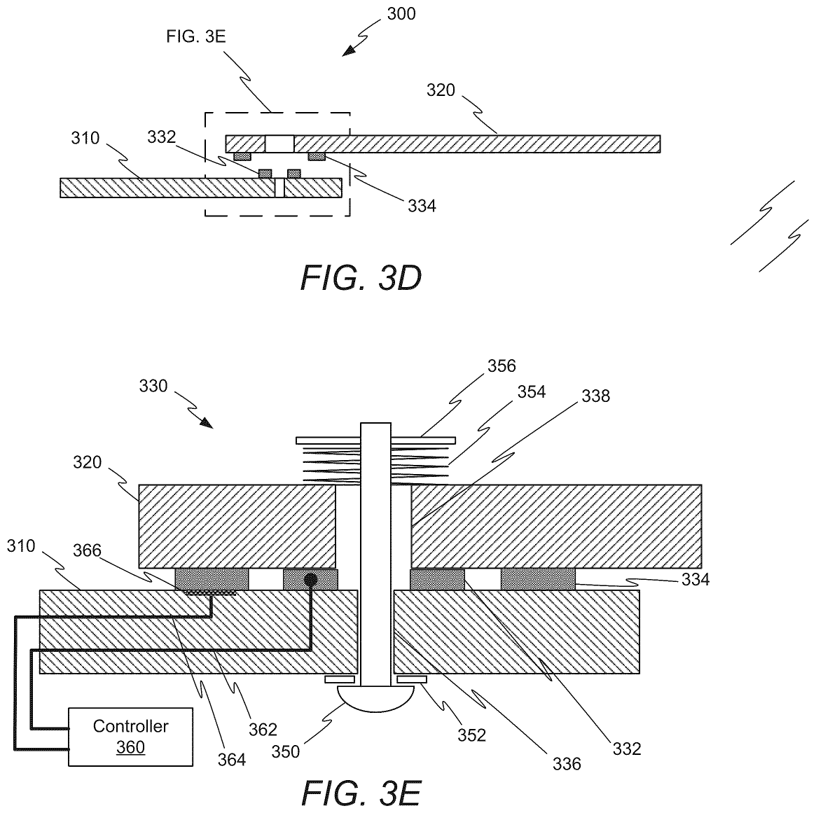

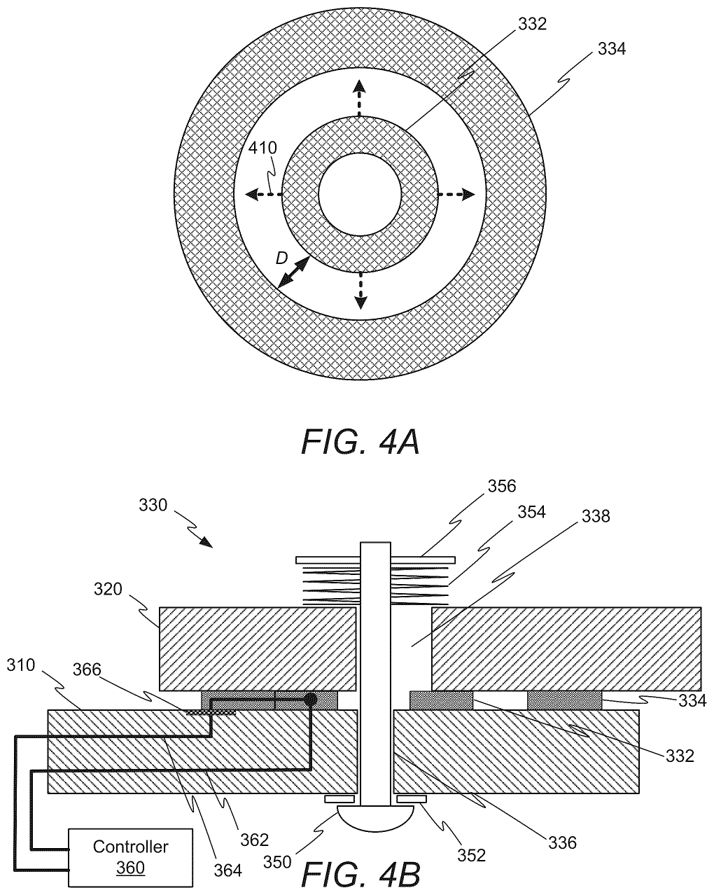

### End Effector 300 (FIGS. 3A-4B)

In order to better appreciate and understand the present disclosure, reference is first made to FIGS. 3A to 3E. FIG. 3A is a simplified top view illustration of an end effector 300 according to some embodiments. Unlike end effector 100, the body of end effector 300 is divided into two primary, separate parts: a base portion 310 (shown separately in FIG. 3B) and a wafer support platform 320 (shown separately in FIG. 3C, and referred to herein sometimes as just “support platform 320”) joined together at a slidable joint 330 and aligned longitudinally along a length of the end effector.

Base portion 310 can be adapted to be coupled to a robot. For example, in the depicted embodiment base portion 310 includes multiple apertures 312 that enable end effector 300 to be attached to a robot (e.g., with screws or other appropriate fasteners). In other embodiments, the base portion can be coupled to a robot with a different number of and/or different pattern of apertures, with a different mechanism or can be coupled to a robot through one or more intermediate structures. Support platform 320 can include a wafer support surface adapted to support a wafer. In the depicted embodiment, the wafer support surface includes first and second fingers 322, 324 disposed in a spaced apart relationship at a distal end of end effector 300.

Slidable joint 330 includes two concentric metal rings. A first inner ring 332 formed on an upper surface of base plate 310 and a second outer ring 334 formed on a lower surface of support platform 320. As shown in FIG. 3D, which is a simplified cross-sectional view of end effector 300 with base portion 310 and support platform 320 in a spaced apart, unconnected relationship, inner ring 332 and outer ring 334 are sized such that an outer perimeter of inner ring 332 fits within the inner perimeter of ring 334 in a spaced apart relationship, the distance of which defines how far the joint 330 can slide in any of the horizontal directions along the x- or y-axes as discussed below with respect to FIG. 4A. In some embodiments, the distance between the outer perimeter of ring 332 and the inner perimeter of ring 334 is less than one millimeter, and in one particular embodiment, the distance between the outer perimeter of ring 332 and the inner perimeter of ring 334 is about 0.5 mm.

Each of the rings 332, 334 can be made from any appropriate electrically conductive material and are referred to herein as “metal rings” for convenience. As non-limiting examples, the metal rings can be made from copper, stainless steel or other electrically conductive materials. Each metal ring can be attached to its respective component (i.e., ring 332 to base portion 310 or ring 334 to support platform 320) using any appropriate technique. As non-limiting examples, in some embodiments metal ring 332 can be co-molded with base portion 310, affixed to base portion 310 with one or more fasteners, or adhered to base portion 310 with an appropriate adhesive. Metal ring 334 can be attached to support platform 320 with any of those same techniques.

Referring now to FIG. 3E, which is an expanded cross-sectional view of a portion of end effector 300 shown in FIG. 3D with base portion 310 and support platform 320 coupled together by slidable joint 330. As shown, slidable joint 330 includes a fastener 350 that extends through apertures 336, 338. One end of fastener 350 includes a washer 352 or similar structure than secure the fastener against base portion 310. At the opposing end of fastener 350 is a spring 354 that is sandwiched between support platform 320 and an end plate 356 of the fastener. Spring 354 provides a bias that holds (clamps) base portion 310 and support platform 320 together such that metal rings 332, 334 are generally coplanar with each other. Spring 354 can be calibrated so that base portion 310 and support platform 320 are held securely together in a fixed position under typical movement and accelerations forces that end effector 300 is subject to under normal operation and slide only if the end effector is subject to a force that is greater than a predetermined force (e.g., greater than a force that was previously determined to potentially cause breakage of one or more of the wafer, end effector 300 or robot). Spring 354 can be any spring mechanism that is capable of compressing support platform 320 into base portion 310 with the desired amount of spring force and, in some embodiments, spring 354 can be a Belleville compression spring.

End effector 300 can include an electrical sensing mechanism that detects when the metal rings 332, 334 slide, with respect to each other, beyond a predetermined amount. As depicted in FIG. 3E, the sensing mechanism can include conductive traces 362, 364 that extend from a controller 360 (e.g., a controller or similar processor that controls the operation of the robot to which end effector 300 is attached) toward the metal rings 332, 334. Since metal ring 332 is physically attached to base portion 310, conductive trace 362 can be directly connected to the metal ring. In contrast, during normal operation metal ring 334 is pressed against base portion 310 but is not mechanically affixed to the base portion. Thus, in some embodiments, base portion 310 can include a conductive pad 366 positioned such that metal ring 334 is in physical contact with the conducive pad when the support platform 320 is biased into the base portion by spring 354.

In some embodiments, base plate 310 and support component 320 are made from alumina or a similar electrically nonconductive material. Thus, in normal operation, when metal rings 332, 334 are spaced apart from each other, they are not in electrical contact with each other and the electrical traces 362, 364 are part of an open circuit. When end effector 300 is subject to sufficient force to overcome the force applied by spring 354, base portion 310 and support plate 320 slide with respect to each other such that the inner metal ring and outer metal ring move with respect to each other. As presented in FIG. 4A, which is a simplified diagram illustrating possible slidable movement between the wafer carrier and base portions according to some embodiments, embodiments enable the rings 332, 334 to slide with respect to each other in any of the horizontal directions indicated by arrows 410 or any horizontal directional in between the depicted cardinal directions.

When the force is sufficient and the metal rings 332, 334 are moved with respect to each other by the distance/), the outer diameter of metal ring 332 contacts the inner diameter of metal ring 334 as shown in FIG. 4B, which is a simplified cross-sectional view illustration of the end effector 300 at such a point in time, and a short circuit is formed. Controller 360 can detect the contact between the rings (i.e., detect the short circuit) and generate an interrupt signal to cease motion of end effector 300 in order to prevent potential damage to the end effector, a sample or wafer supported by the end effector and/or the robot that the end effector is coupled to.

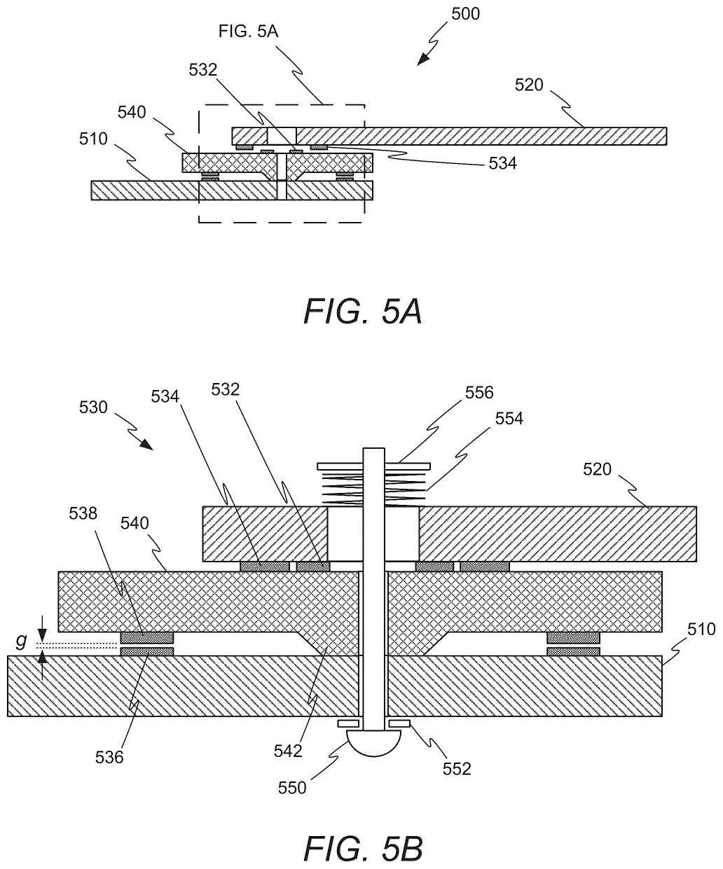

### End Effector 500 (FIGS. 5A-5B)

The embodiment discussed above allow the base plate and support platform to slide with respect to each other along the x- and y-axis and can prevent damage to the sample, end effector and/or robot when such movement occurs. Some embodiments further provide protection against movement along the z-axis. One such embodiment is discussed below with respect to FIGS. 5A and 5B where FIG. 5A is a simplified cross-sectional view illustration of an end effector 500 according to some embodiments, and FIG. 5B is an expanded cross-sectional view of a slidable joint that can be used to join the wafer carrier and base portions of end effector 500 according to some embodiments.

As shown in FIGS. 5A and 5B, end effector 500 includes multiple separate plates, including: a base portion 510, a support platform 520 and an intermediate plate 540 that are jointed together by a slidable joint 530. Support platform 520 can be substantially similar to support platform 320 discussed above (and thus include fingers, not shown, at its distal end similar to fingers 322, 324) while base portion 510 can be substantially similar to base portion 310 (and thus can include multiple apertures, not shown, that enable end effector 500 to be attached to a robot). Intermediate plate 540 can be a thin plate made from alumina or a similar material that is positioned between base portion 510 and support platform 520. While not shown, from a top or bottom view, intermediate plate 540 can be generally rectangular with a length as shown in FIG. 5A and a width similar to the width of the portions of base plate 510 and support platform 520 that it is sandwiched between.

Slidable joint 330 includes two separate sets of metal rings that cooperate to detect and prevent unintended movement along any the x-, y- or z-axes from damaging the end effector, a sample or wafer supported by the end effector and/or the robot to which end effector 500 is attached. The slidable joint can also include a fastener 550 that extends through apertures (not labeled, but visible in each of FIGS. 5A and 5B) on each of base portion 510, intermediate plate 540 and support platform 520) 336, 338. Similar to fastener 350, one end of fastener 550 includes a washer 552 or similar structure that sits between a head of the fastener and base portion 510. At the opposing end of fastener 550 is a spring 554 that is sandwiched between support platform 520 and an end plate 556 of the fastener. Spring 554 provides a bias that holds base portion 510, intermediate plate 540 and support platform 520 together. Spring 554 can be calibrated so that three plates (base portion 510, intermediate plate 540 and support platform 520) are held securely together under typical movement and accelerations forces that end effector 500 is subject to under normal operation and slide or otherwise move only if the end effector is subject to a force that is greater than a predetermined force (e.g., greater than a force that was previously determined to potentially cause breakage of one or more of the wafer, end effector 500 or robot). Spring 554 can be any spring mechanism that is capable of compressing support platform 520, intermediate plate 540 and base portion 510 together with the desired amount of spring force. In some embodiments, spring 554 can be a Belleville compression spring.

A first set of metal rings in slidable joint 530 includes an inner ring 532 at the upper surface of intermediate plate 540 and an outer ring 534 at the lower surface of support platform 520. Metal rings 532, 534 can be sized and shaped similar to, and operate to detect unintended movement along the x- and/or y-axes similarly as, metal rings 332 and 334 described above with respect to end effector 300. Thus, for the sake of brevity, further details of the electrical circuit that can be formed (or not formed) between rings 552 and 554 are not presented herein.

The second set of metal rings in slidable joint 530 includes a ring 536 at an upper surface of base portion 510 and a ring 538 at a lower surface of intermediate plate 540. As shown in FIGS. 5A and 5B, metal rings 536, 538 can be positioned directly opposite each other and spaced apart by a distance, g, such that, when the end effector is fully assembled with fastener 550, the metal rings are not in physically contact with each other. The gap, g, can be formed by a neck 542 of intermediate plate 540 that is centered around the aperture through which fastener 550 extends. Neck 542 creates a cantilevered coupling between wafer support portion 520 and base portion 510 such the neck 542 creates a pivot point when a force is applied along the z-axis to one of base portion 510 or wafer support portion 520 at a distance away from the neck 542.

An electrical circuit (not shown) can be formed through rings 536, 538 and monitored by a controller, such as controller 360 shown in FIGS. 3E and 4B. In normal operation, the circuit is normally an open circuit, but if during the operation of end effector 500, a portion of the end effector (or a sample or wafer transported by the end effector) unintentionally collides with an object while the end effector is moving along the z-axis, the collision can tilt one of body portion 510 or wafer support platform 520 around the pivot point created by neck 542 thereby forcing the metal rings 536, 538 to come into contact with each other creating a closed circuit that can be detected by a controller.

In other embodiments, instead of neck 542, a compressible gasket (not shown) or similar structure can be disposed between intermediate plate 540 and base portion 510. As a non-limiting example, the gasket can be an O-ring concentric with metal rings 536, 538 but having an outer diameter that is less than an inner diameter of the metal rings. The gasket can be chosen to have physical properties that allow it to compress under force such that the clamping force applied by spring 554 is insufficient to compress the gasket enough to allow metal rings 536, 538 to contact each other. That is, the physical properties of the compressible gasket hold base portion 510 and intermediate portion 540 apart by a sufficient distance to ensure the gap, g, between metal rings 536, 538. The compressible gasket can also be selected, however, such that when a force that is greater than the bias force by a predetermined amount (e.g., greater than a force that was previously determined to potentially cause breakage of one or more of the wafer, end effector 500 or robot) is applied to end effector 500 along the z-axis, the gasket compresses further allowing the metal rings 536, 538 to come into contact with each other forming a metal-on-metal contact.

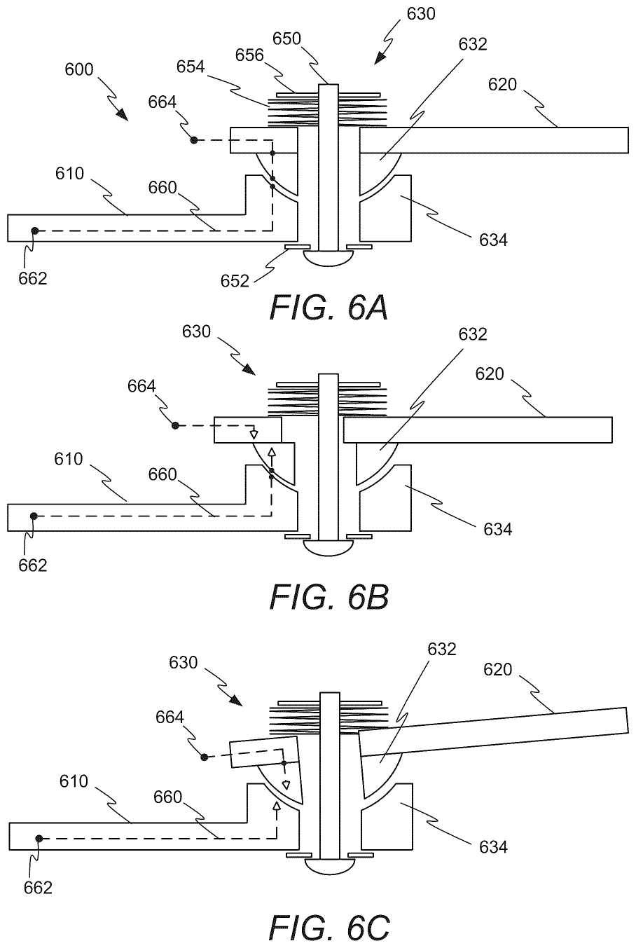

### End Effector 600 (FIGS. 6A-6C)

Reference is now made to FIG. 6A, which is a simplified cross-sectional view illustration of an end effector 600 according to some embodiments. End effector 600 includes a base portion 610 and a support platform 620. Base portion 510 can be similar to base portion 310 in that it can be a very thin plate made from a material, such as alumina, and can include multiple apertures, not shown, that enable end effector 600 to be attached to a robot. Support platform 520 can be similar in shape and function to support platform 320 discussed above and include fingers, not shown, at its distal end similar to fingers 322, 324.

Base plate 610 and support platform 620 can be coupled together by a slidable joint 630. As shown, slidable joint 630 includes a ball and socket configuration that are held together by a fastener 650. Specifically, joint 630 can include a ball portion 632 formed at a lower surface of support platform 620 that mates with a socket portion 634 formed at an upper surface of base portion 610. Slidable joint 630 can also allow wafer support platform 620 to slide with respect to ball portion 632. A fastener 650 can secure the joint together thus securing base portion 810 to support platform 620. Fastener 650 can be similar to fasteners 350 and 550 discussed above and include the same or similar components, including a washer 652 similar to washer 352, a spring 654 similar to spring 354, and a base plate 656 similar to base plate 356.

Spring 656 can be calibrated so that base portion 610 and support platform 620 are held securely together by the ball and socket joint under typical movement and accelerations forces that end effector 600 is subject to under normal operation. But, if the end effector is subject to a force that is greater than a predetermined force (e.g., greater than a force that was previously determined to potentially cause breakage of one or more of the wafer, end effector 600 or robot), the imparted force will overcome the biasing force and the ball and socket pairing 632, 634 will slide with respect to each other (as shown in FIG. 6C) or the wafer support component 620 will slide with respect to the ball portion 632 (as shown in FIG. 6B).

To detect movement between ball 632 and socket 634 that might otherwise result in damage to the end effector, end effector 600 can include an electrical circuit that can include conductive traces or lines that extend through at least a portion of base portion 610, socket 634, ball 632 and at least a portion of support plate 620. For example, as shown in FIG. 6A, electric circuit 660 can present, during normal operation of end effector 600, an uninterrupted circuit between nodes 662 and 664 as shown schematically by the dashed line representing circuit 660. Connections in the circuit 660 at the interfaces of the different components (e.g., at the interface of wafer support platform 620 and ball portion 632, at the interface between ball portion 632 and socket portion 634 and at the interface between socket portion 634 and base portion 610) are depicted schematically as small dots without reference numbers. A controller (e.g., controller 360) can monitor circuit 660 to detect any changes in the voltage or current level over the circuit.

FIG. 6B is a simplified cross-sectional view illustration of the end effector shown in FIG. 6A in which support platform 620 has shifted (slid) horizontally after an impact event. As shown, circuit 660 is broken (indicated by the arrows in circuit 660 as opposed to the dots depicted in FIG. 6A) by the lateral movement of ball 632 within socket 634 at the point where ball 632 is connected to base plate 620. The controller can detect the change in circuit 660 and generate an interrupt signal to stop the robot to which end effector 600 is coupled from effecting further movement of the end effector thereby preventing potential damage to the end effector, a sample or wafer supported by end effector 600 and/or the robot itself.

Similarly, FIG. 6C is a simplified cross-sectional view illustration of the end effector shown in FIG. 6A in which support platform has shifted (slid) vertically after an impact event. As shown, circuit 660 is broken (also indicated by the arrows in circuit 660 as opposed to the dots depicted in FIG. 6A) by the lateral movement of ball 632 within socket 634 at a point where ball 632 mates with socket 634. The controller can detect the change in circuit 660 and generate an interrupt signal to stop the robot to which end effector 600 is coupled from effecting further movement of the end effector thereby preventing potential damage to the end effector, a sample or wafer supported by end effector 600 and/or the robot itself.

### ADDITIONAL EMBODIMENTS

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. For example, while embodiments discussed above included an inner disposed below an outer rings, in other embodiments the inner ring can be formed at the lower surface of the support platform and the outer ring can be positioned beneath that. In still other embodiments, structures other than electrically conductive rings or ball and socket joints can be used. For example, in some embodiments a groove could be cut into one of the opposing surfaces of the base portion or support platform and lined with an electrically conductive material along the inner periphery and outer periphery sidewalls of the groove. An electrically conductive ring or similar structure formed at the other opposing surface can then slide within the groove and trigger an interrupt condition if it slides sufficiently far to contact the electrically conductive liner.

As additional examples, while embodiments discussed above included a sensor that detected an undesired amount of movement based on an electric circuit was short circuited or set into an open circuit state, in other embodiments, other types of sensors can be used to detect (sense) the distance in which the base portion and wafer support platform move with respect to each other. For example, in some embodiments the various metal rings can be arranged as capacitive plates and a sensor can detect when the capacitance changes beyond a predetermined level. As another example, an optical sensor can be employed to measure the distance between the rings or between markings or other features formed on or attached to one or both of the base portion and/or wafer support platform.

As still an additional example, while slidable joints depicted in the above-described embodiments all included a fastener with a spring disposed between an end plate at a distal end of the fastener and a top surface of the wafer support platform, in other embodiments the fastener can be in an opposite position such that the spring is disposed between the end plate and a lower surface of the base portion. Additionally, while the embodiments described above all included the wafer support platform positioned on top of the base portion, in other embodiments the base portion can be above the wafer support platform.

Also, while different embodiments of the disclosure were disclosed above, the specific details of particular embodiments may be combined in any suitable manner without departing from the spirit and scope of embodiments of the disclosure. Further, it will be apparent to one of ordinary skill in the art that many modifications and variations are possible in view of the above teachings. It is, therefore, to be understood that the appended claims are intended to cover all such modifications and changes as fall within the true spirit of the embodiments of the disclosure.

It should be noted that various figures in the present application are not drawn to scale and are drawn in a highly simplified format to illustrate various concepts and features of embodiments disclosed herein. As an example, FIGS. 6A to 6C show a small gap between ball portion 632 and socket portion 634 within the slidable joint 630. The gap is included in the figures so that the two components can be more clearly seen as separate parts. Based on the description surrounding FIGS. 6A to 6C, a skilled artisan will realize that fastener 650 compresses ball portion 632 and socket portion 634 together during normal operation such that the two components will actually be in contact with each other and not separated by a gap as depicted.

It should also be noted that any reference in the specification above to a method can be applied mutatis mutandis to a system capable of executing the method and should be applied mutatis mutandis to a computer program product that stores instructions that once executed result in the execution of the method. Similarly, any reference in the specification above to a system can be applied mutatis mutandis to a method that may be executed by the system should be applied mutatis mutandis to a computer program product that stores instructions that can be executed by the system; and any reference in the specification to a computer program product should be applied mutatis mutandis to a method that may be executed when executing instructions stored in the computer program product and should be applied mutandis to a system that is configured to executing instructions stored in the computer program product.

Also, where the illustrated embodiments of the present disclosure can, for the most part, be implemented using electronic components and circuits known to those skilled in the art, details of such are not be explained in any greater extent than that considered necessary as illustrated above, for the understanding and appreciation of the underlying concepts of the present disclosure and in order not to obfuscate or distract from the teachings of the present disclosure.

What is claimed is:

1. An apparatus for handling and transporting wafers, the apparatus comprising:
an end effector comprising:
a base portion having a first end adapted to be coupled to a robot;
a wafer support platform having a surface to support a wafer;
a slidable joint coupling the base portion to the wafer support platform; and
a sensor configured to detect when the wafer support platform slides relative to the base portion beyond a predetermined distance.

2. The apparatus set forth in claim 1 wherein the slidable joint comprises a spring that biases the wafer support platform towards the base portion by imparting a biasing force that clamps the base portion and the wafer support platform in a fixed position until a force greater than the biasing force is imparted upon the end effector causing the wafer support platform to slide relative to the base portion.

3. The apparatus set forth in claim 1 wherein the base portion further includes a second end opposite the first end, the wafer support platform includes first and second opposing ends with a plurality of fingers at the second end of the wafer support platform, and the slidable joint couples the second end of the base portion to the first end of the wafer support platform such that the base portion and wafer support platform are aligned longitudinally along a length of the end effector with the plurality of fingers at a distal end of the end effector.

4. The apparatus set forth in claim 1 wherein the slidable joint comprises first and second coplanar concentric rings, wherein the first ring is positioned at a surface of one of the base portion or wafer support platform and the second ring is positioned at an opposing surface of the other of the base portion or wafer support platform, and wherein the first and second rings are sized such that an outer diameter of the first ring fits within and is spaced apart from an inner diameter of the second ring.

5. The apparatus set forth in claim 4 further comprising a controller operatively coupled to the sensor and configured to stop movement of the end effector if the sensor detects that the wafer support platform slid horizontally with respect to the base portion more than the predetermined distance.

6. The apparatus set forth in claim 5 wherein a distance between the outer diameter of the first ring to the inner diameter of the second ring defines the predetermined distance.

7. The apparatus set forth in claim 6 wherein the distance between the outer diameter of the first ring to the inner diameter of the second ring is 1.0 mm or less.

8. The apparatus set forth in claim 4 wherein:
the second end of the base portion includes a first aperture;
the first end of the wafer support platform includes a second aperture aligned with the first aperture;
the slidable joint includes a fastener that extends through the first and second apertures, the fastener having an end plate at its distal end; and
the spring is disposed between the end plate and one of the wafer support platform or the base portion.

9. The apparatus set forth in claim 4 wherein the sensor comprises electrically conductive lines that form a short circuit when the first and second rings come into physical contact with each other.

10. The apparatus set forth in claim 1 wherein the slidable joint comprises a ball and socket joint.

11. The apparatus set forth in claim 1 wherein the base portion includes a plurality of apertures at its first end in a configuration that enables the base portion to be attached to the robot.

12. The apparatus set forth in claim 1 further comprising an intermediate plate secured in a fixed position between the base portion and the wafer support platform by the slidable joint.

13. The apparatus set forth in claim 12 wherein:
the slidable joint comprises first and second sets of electrically conductive rings;
the first set of electrically conductive rings comprises first and second coplanar concentric rings, with the first ring positioned at a surface of one of the wafer support platform or the intermediate plate and the second ring positioned at an opposing surface of the other of the wafer support platform or intermediate plate;
the first and second rings are sized such that an outer diameter of the first ring fits within and is spaced apart from an inner diameter of the second ring; and
the second set of electrically conductive rings comprises third and fourth coplanar concentric rings disposed in an oppositional relationship with the third ring positioned at a surface of the intermediate plate and the fourth ring positioned at a surface of the base portion; wherein the third and fourth rings are spaced apart from each other along the z-axis by a gap that prevent the rings from contacting each other during normal operation of the end effector.

14. An apparatus for handling and transporting wafers, the apparatus comprising:
an end effector comprising:
a base portion having a first end adapted to be coupled to a robot and a second end opposite the first end;
a wafer support platform having first and second opposing ends with a support surface adapted to support a wafer at the second end, the support surface including a plurality of fingers spaced apart from each other;
a slidable joint coupling the second end of the base portion to the first end of the wafer support platform such that the base portion and wafer support platform are aligned longitudinally along a length of the end effector with the plurality of fingers at a distal end of the end effector, wherein the slidable joint comprises a spring that biases the wafer support platform towards the base portion by imparting a biasing force that clamps the base portion and the wafer support platform in a fixed position until a force greater than the biasing force is imparted upon the end effector causing the wafer support platform to slide relative to the base portion; and
a sensor configured to detect when the wafer support platform slides relative to the base portion beyond a predetermined distance.

15. An end effector for handling and transporting wafers, the end effector comprising:
a base portion having first and second opposing ends, the first end adapted to enable the base portion to be coupled to a robot;
a wafer support platform having first and second opposing ends and a support surface to support a thin wafer;
a slidable joint coupling the second end of the base portion to the first end of the wafer support platform such the base portion and wafer support platform are aligned longitudinally along a length of the end effector with the plurality of apertures and the wafer support surface at opposing ends of the end effector, the slidable joint including a spring that biases the wafer support platform towards the base portion by imparting a biasing force that clamps the base portion and wafer support platform in a fixed position until a separate force, greater than the biasing force, is imparted upon the end effector that overcomes the biasing force causing the wafer support platform to slide relative to the base portion; and
a sensor configured to detect when the wafer support platform slides relative to the base portion beyond a predetermined distance.

16. The end effector set forth in claim 15 wherein:
the slidable joint comprises first and second coplanar concentric rings with the first ring is positioned at a surface of one of the base portion or wafer support platform and the second ring positioned at an opposing surface of the other of the base portion or wafer support 4 platform;
the first and second rings are sized such that an outer diameter of the first ring fits within and is spaced apart from an inner diameter of the second ring; and
a distance between the outer diameter of the first ring to the inner diameter of the second ring defines the predetermined distance.

17. The end effector set forth in claim 16 wherein:
the second end of the base portion includes a first aperture;
the first end of the wafer support platform includes a second aperture aligned with the first aperture;
the slidable joint includes a fastener that extends through the first and second apertures, the fastener having an end plate at its distal end; and
the spring is disposed between the end plate and one of the wafer support platform or the base portion.

18. The end effector set forth in claim 16 wherein the sensor comprises electrically conductive lines that form a short circuit when the first and second rings come into physical contact with each other.

19. The end effector set forth in claim 15 wherein the slidable joint comprises a ball and socket joint.

20. The end effector set forth in claim 15 further comprising an intermediate plate secured in a fixed position between the base portion and the wafer support platform by the slidable joint; and wherein:
the slidable joint comprises first and second sets of electrically conductive rings;
the first set of electrically conductive rings comprises first and second coplanar concentric rings, with the first ring positioned at a surface of one of the wafer support platform or the intermediate plate and the second ring positioned at an opposing surface of the other of the wafer support platform or intermediate plate;
the first and second rings are sized such that an outer diameter of the first ring fits within and is spaced apart from an inner diameter of the second ring; and
the second set of electrically conductive rings comprises third and fourth coplanar concentric rings disposed in an oppositional relationship with the third ring positioned at a surface of the intermediate plate and the fourth ring positioned at a surface of the base portion; wherein the third and fourth rings are spaced apart from each other along the z-axis by a gap that prevent the rings from contacting each other during normal operation of the end effector.
